(19) United States
(12) Patent Application Publication
(10) Pub. No.: US 2007/0218192 A1
(43) Pub. Date: Sep. 20, 2007

(54) Method of manufacturing interconnect substrate

(75) Inventors: Satoshi Kimura, Fujimi (JP); Hidemichi Furihata, Chino (JP); Toshihiko Kaneda, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/716,738

(22) Filed: Mar. 9, 2007

(30) Foreign Application Priority Data
Mar. 10, 2006 (JP) 2006-65991

(51) Int. Cl. B05D 5/12; B28B 19/00

(52) U.S. Cl. 427/99.1; 427/99.5

(57) ABSTRACT

A method of manufacturing an interconnect substrate having a linear interconnect by electroless plating without using a plating resist, the method including: (a) forming a plurality of rows of linear catalyst layers on a substrate; and (b) depositing a metal on the linear catalyst layers by electroless plating to form a plurality of rows of linear metal layers, at least one of the rows of linear catalyst layers having a line width of 2 micrometers or less, and a total line width of the linear catalyst layers on the substrate being 10 micrometers or more.

Japanese Patent Application No. 2006-65991, filed on Mar. 10, 2006, is hereby incorporated by reference in its entirety.

### BACKGROUND OF THE INVENTION

The present invention relates to a method of manufacturing an interconnect substrate.

Electroless plating has attracted attention as a method of manufacturing an interconnect substrate. In electroless plating, a metal is deposited by reducing metal ions in an electroless plating solution by the function of a reducing agent. Therefore, since it is unnecessary to cause current to flow through the solution, a metal can also be deposited on an insulating substrate. Along with a recent increase in density of electronic instruments, it has become necessary to form a minute interconnect pattern by electroless plating.

However, since electroless plating reaction, in which a metal is deposited on a catalyst layer, does not occur when the area of the catalyst layer is not sufficiently large, it is difficult to form a minute interconnect pattern by electroless plating.

### SUMMARY

According to a first aspect of the invention, there is provided a method of manufacturing an interconnect substrate having a linear interconnect by electroless plating without using a plating resist, the method comprising:

(a) forming a plurality of rows of linear catalyst layers on a substrate; and

(b) depositing a metal on the linear catalyst layers by electroless plating to form a plurality of rows of linear metal layers,

at least one of the rows of linear catalyst layers having a line width of 2 micrometers or less, and a total line width of the linear catalyst layers on the substrate being 10 micrometers or more.

According to a second aspect of the invention, there is provided a method of manufacturing an interconnect substrate by electroless plating without using a plating resist, the method comprising:

(a) forming catalyst layers in a plurality of regions on a substrate; and

(b) depositing a metal on the catalyst layers by electroless plating to form metal layers in the regions,

part of the catalyst layers formed in at least one of the regions having an area of 4 square micrometers or less, and a total area of the catalyst layers being 49 square micrometers or more.

### BRIEF DESCRIPTION OF THE SEVERAL VIEWS OF THE DRAWING

FIG. 1 is a diagram showing a method of manufacturing an interconnect substrate according to a first embodiment of the invention.

FIG. 2 is a diagram showing the method of manufacturing an interconnect substrate according to the first embodiment.

FIG. 3 is a diagram showing the method of manufacturing an interconnect substrate according to the first embodiment.

FIG. 4 is a diagram showing the method of manufacturing an interconnect substrate according to the first embodiment.

FIG. 5 is a diagram showing the method of manufacturing an interconnect substrate according to the first embodiment.

FIG. 6 is a diagram showing the method of manufacturing an interconnect substrate according to the first embodiment.

FIG. 7 is a diagram showing the method of manufacturing an interconnect substrate according to the first embodiment.

FIG. 8 is a diagram showing the method of manufacturing an interconnect substrate according to the first embodiment.

FIG. 9 is a diagram showing the method of manufacturing an interconnect substrate according to the first embodiment.

FIG. 10 is a diagram showing the method of manufacturing an interconnect substrate according to the first embodiment.

FIG. 11 is a graph showing measurement results according to a first experimental example of the invention.

FIG. 12 shows an example of an electronic device to which an interconnect substrate according to one embodiment of the invention is applied.

FIG. 13 is a diagram showing a method of manufacturing an interconnect substrate according to a modification of the first embodiment.

FIG. 14 is a diagram showing a method of manufacturing an interconnect substrate according to a second embodiment of the invention.

FIG. 15 is a graph showing measurement results according to a third experimental example of the invention.

FIG. 16 is a diagram showing a method of manufacturing an interconnect substrate according to a modification of the second embodiment.

### DETAILED DESCRIPTION OF THE EMBODIMENT

The invention may provide a method of manufacturing an interconnect substrate capable of forming a minute interconnect pattern by electroless plating.

According to one embodiment of the invention, there is provided a method of manufacturing an interconnect substrate having a linear interconnect by electroless plating without using a plating resist, the method comprising:

(a) forming a plurality of rows of linear catalyst layers on a substrate; and

(b) depositing a metal on the linear catalyst layers by electroless plating to form a plurality of rows of linear metal layers,

at least one of the rows of linear catalyst layers having a line width of 2 micrometers or less, and a total line width of the linear catalyst layers on the substrate being 10 micrometers or more.

This makes it possible to form the metal layers with a uniform thickness even when forming minute interconnects with a line width of 2 micrometers or less, whereby the reliability of the interconnect substrate can be improved.

In this method of manufacturing an interconnect substrate, the total line width of the linear catalyst layers on the substrate may be 20 micrometers or more.

In this method of manufacturing an interconnect substrate, the rows of metal layers may include interconnects and dummy interconnects.

In this method of manufacturing an interconnect substrate, the dummy interconnects may be formed on both sides of the interconnect.

According to one embodiment of the invention, there is provided a method of manufacturing an interconnect substrate by electroless plating without using a plating resist, the method comprising:

(a) forming catalyst layers in a plurality of regions on a substrate; and

(b) depositing a metal on the catalyst layers by electroless plating to form metal layers in the regions,

part of the catalyst layers formed in at least one of the regions having an area of 4 square micrometers or less, and a total area of the catalyst layers being 49 square micrometers or more.

This makes it possible to form the metal layers with a uniform thickness even when forming minute interconnects with an area of the separated region of 4 square micrometers or less, whereby the reliability of the interconnect substrate can be improved.

In this method of manufacturing an interconnect substrate, another catalyst layer for forming a dummy interconnect may be formed around the part of the catalyst layers formed in the one region.

The above-described methods of manufacturing an interconnect substrate may further comprise:

forming a resist layer on the substrate in a region other than a region of a desired interconnect pattern before the step (a); and

forming a surfactant layer on the substrate before the step (a),

wherein the step (a) includes:

forming a catalyst layer on the surfactant layer; and

removing the resist layer to remove part of the surfactant layer and the catalyst layer in the region other than the region of the desired interconnect pattern.

In the step (b) of the above-described methods of manufacturing an interconnect substrate, nickel may be deposited on the catalyst layers by immersing the substrate in an electroless plating solution including nickel.

Some embodiments of the invention will be described below with reference to the drawings.

### 1. First Embodiment

A first embodiment of the invention is described below.

### 1.1. METHOD OF MANUFACTURING INTERCONNECT SUBSTRATE

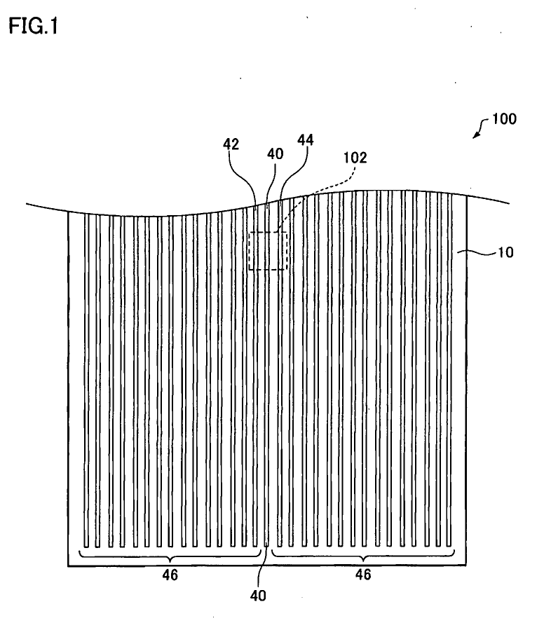

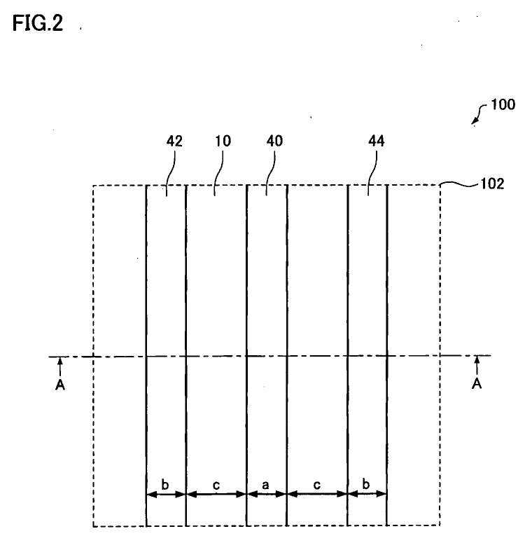

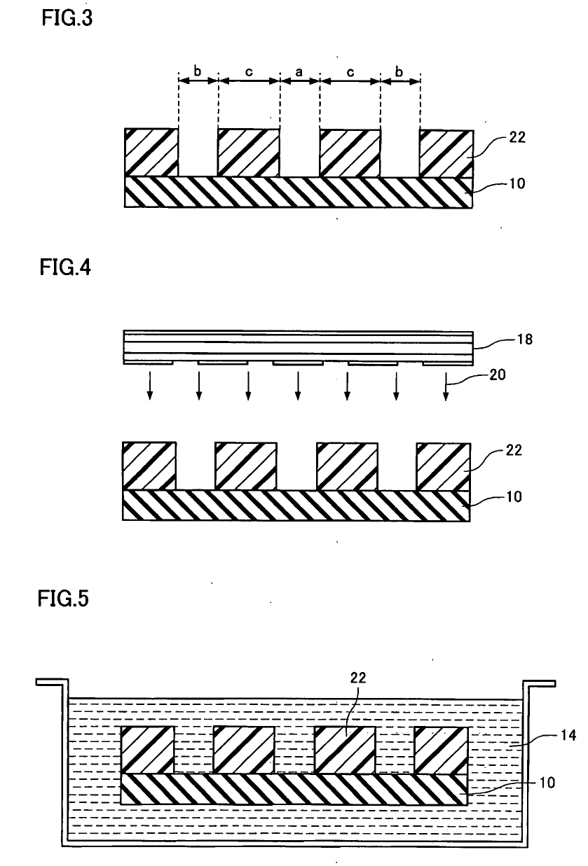

FIGS. 1 to 10 are diagrams showing an example of a method of manufacturing an interconnect substrate 100 (see FIG. 10) according to the first embodiment. FIGS. 1 and 2 are plan diagrams showing an example of the method of manufacturing an interconnect substrate according to the first embodiment. FIG. 2 is an enlarged diagram of a region 102 shown in FIG. 1. FIGS. 3 to 10 are cross-sectional diagrams of the interconnect substrate taken along the line A-A in FIG. 2.

(1) A substrate 10 is provided. The substrate 10 may be an insulating substrate, as shown in FIG. 3. The substrate 10 may be an organic substrate (e.g. plastic material or resin substrate) or an inorganic substrate (e.g. quartz glass, silicon wafer, or oxide layer). As examples of the plastic material, polyimide, polyethylene terephthalate, polycarbonate, polyphenylene sulfide, and the like can be given. The substrate 10 may be a light-transmitting substrate (e.g. transparent substrate). The substrate 10 includes a single-layer substrate and a multilayer substrate in which at least one insulating layer is formed on a base substrate.

A resist layer 22 is formed. The resist layer 22 may be formed as shown in FIG. 3 by applying a resist (not shown) to the top surface of the substrate 10 and patterning the resist using a lithographic method.

The region in which the resist layer 22 is formed is a region other than a region in which a catalyst layer 32 described later is formed. The resist layer 22 is formed to have a plurality of linear openings, and the catalyst layer 32 and a metal layer 34 described later are formed in the opening. As shown in FIG. 1, the openings are formed in regions 40 and 46, for example.

(2) The substrate 10 is washed. The substrate 10 may be dry-washed or wet-washed. It is preferable to dry-wash the substrate 10. The resist layer 22 can be prevented from being damaged (e.g. separated) by dry-washing the substrate 10.

As shown in FIG. 4, the substrate 10 may be dry-washed by applying vacuum ultraviolet radiation for 30 to 900 seconds in a nitrogen atmosphere using a vacuum ultraviolet lamp. Soil such as oils adhering to the surface of the substrate 10 can be removed by washing the substrate 10. Moreover, the water-repellent surfaces of the substrate 10 and the resist layer 22 can be made hydrophilic. When the surface potential in liquid of the substrate 10 is negative, a surface at a uniform negative potential can be formed by washing the substrate 10.

The substrate 10 may be wet-washed by immersing the substrate 10 in ozone water (ozone concentration: 10 to 20 ppm) at room temperature for 5 to 30 minutes, for example. The substrate 10 may be dry-washed by applying vacuum ultraviolet radiation for 30 to 900 seconds in a nitrogen atmosphere using a vacuum ultraviolet lamp (wavelength: 172 nm, output: 10 mW, sample-to-sample distance: 1 mm).

(3) As shown in FIG. 5, the substrate 10 is immersed in a surfactant solution 14. The surfactant contained in the surfactant solution 14 may be a cationic surfactant or an anionic surfactant. When the surface potential in liquid of the substrate 10 is negative, it is preferable to use the cationic surfactant. This is because the cationic surfactant is easily adsorbed on the substrate 10 in comparison with other surfactants. When the surface potential in liquid of the substrate 10 is positive, it is preferable to use the anionic surfactant as the surfactant contained in the surfactant solution 14.

As the cationic surfactant, a water-soluble surfactant containing an aminosilane component, an alkylammonium surfactant (e.g. cetyltrimethylammonium chloride, cetyltrimethylammonium bromide, or cetyldimethylammonium bromide), or the like may be used. As the anionic surfactant, a polyoxyethylene alkyl ether sulfate (sodium dodecyl sulfate, lithium dodecyl sulfate, or N-lauroylsarcosine) or the like may be used. The immersion time may be about 1 to 10 minutes, for example.

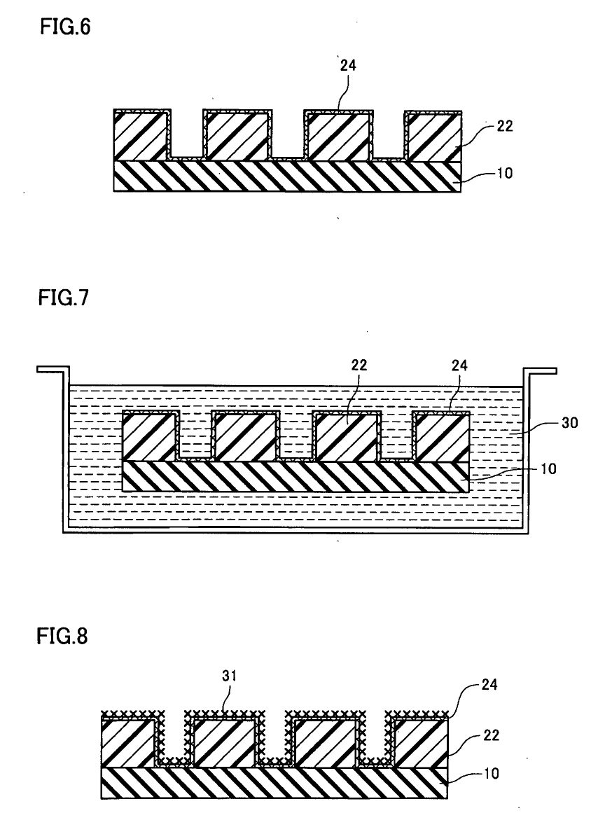

The substrate 10 is removed from the surfactant solution and washed with ultrapure water. After air-drying the substrate 10 at room temperature or removing waterdrops by spraying compressed air, the substrate 10 is dried in an oven at 90 to 120° C. for about 10 minutes to 1 hour. A surfactant layer 24 (see FIG. 6) can be formed on the substrate 10 by the above steps. When using the cationic surfactant, the surface potential in liquid of the substrate 10 is shifted to the positive potential side in comparison with the surface potential before adsorption.

(4) As shown in FIG. 7, the substrate 10 is immersed in a catalyst solution 30. The catalyst solution 30 includes a catalyst component which functions as a catalyst for electroless plating. For example, palladium may be used as the catalyst component.

The catalyst solution 30 may be prepared as follows, for example.

(4a) Palladium pellets with a purity of 99.99% are dissolved in a mixed solution of hydrochloric acid, hydrogen peroxide solution, and water to prepare a palladium chloride solution with a palladium concentration of 0.1 to 0.5 g/l.

(4b) The palladium concentration of the palladium chloride solution is adjusted to 0.01 to 0.05 g/l by diluting the palladium chloride solution with water and a hydrogen peroxide solution.

(4c) The pH of the palladium chloride solution is adjusted to 4.5 to 6.8 using a sodium hydroxide aqueous solution or the like.

The substrate 10 may be washed with water after immersing the substrate 10 in the catalyst solution 30. The substrate 10 may be washed with pure water. A catalyst residue can be prevented from being mixed into an electroless plating solution described later by washing the substrate 10 with water.

A catalyst layer 31 is formed by the above steps. As shown in FIG. 8, the catalyst layer 31 is formed on the top surface of the surfactant layer 24 on the substrate 10 and the resist layer 22.

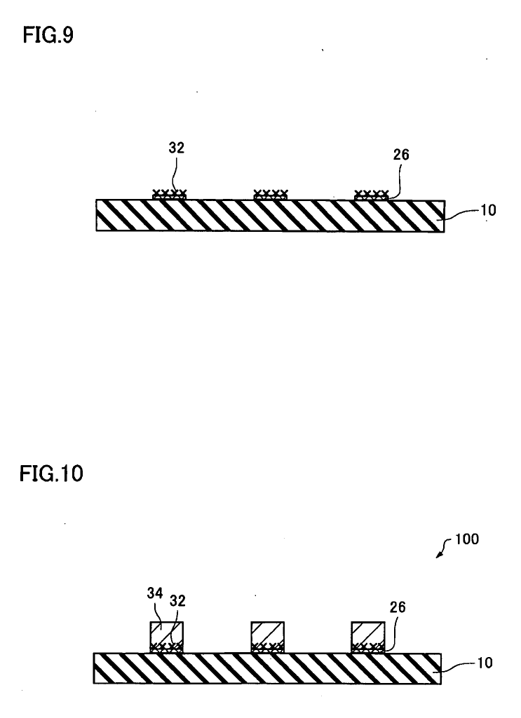

As shown in FIG. 9, the resist layer 22 is removed to form a surfactant layer 26 and a catalyst layer 32 with a desired interconnect pattern. The resist layer 22 may be removed using acetone or the like. The surfactant layer 24 and the catalyst layer 31 formed on the resist layer 22 are also removed together with the resist layer 22.

As shown in FIG. 1, the catalyst layer 32 may have a linear planar shape. A plurality of rows of catalyst layers 32 are formed in the regions 40 and 46. At least one row has a line width of 2 micrometers or less. In FIG. 2, the line width a of the catalyst layer 32 formed in the region 40 may be 2 micrometers or less, for example. The total line width of the catalyst layers 32 on the substrate 10 may be 10 micrometers or more, and preferably 20 micrometers or more. For example, when the number of lines formed on the substrate 10 is n+1 in FIG. 1, the sum (a+nb) of the line width a of the catalyst layer 32 formed in the region 40 and the line widths b of the catalyst layers 32 formed in the regions 46 may be 10 micrometers or more. Note that the line widths a and b may be the same or different. The interval c between the catalyst layers 32 may be twice or less of the line width a, for example.

(5) The metal layer 34 is deposited on the catalyst layer 32 by electroless plating. In more detail, the metal layer 34 may be deposited on the catalyst layer 32 by immersing the substrate 10 in an electroless plating solution including a metal (see FIG. 10).

The electroless plating solution includes a metal, a reducing agent, a complexing agent, and the like. For example, when using nickel as the metal, an electroless plating solution may be used which mainly includes nickel sulfate hexahydrate or nickel chloride hexahydrate and includes sodium hypophosphite as the reducing agent. For example, a nickel layer with a thickness of 20 to 100 nm may be formed by immersing the substrate 10 in an electroless plating solution (temperature: 70 to 85° C.) containing nickel sulfate hexahydrate for about 10 seconds to 10 minutes. The metal is not particularly limited insofar as the metal undergoes plating reaction in the presence of a catalyst. The metal layer may also be formed of platinum (Pt), copper (Cu), gold (Au), or the like. A plurality of rows of linear metal layers 34 can be thus formed in the regions 40 and 46 on the substrate 10 (see FIG. 1).

The interconnect substrate 100 can be formed by the above steps, as shown in FIG. 10. According to the method of manufacturing an interconnect substrate according to this embodiment, an interconnect substrate can be manufactured which includes interconnects formed of linear metal layers with a line width of 2 micrometers or less. The thicknesses of the metal layers 34 can be made uniform by adjusting the total line width of the catalyst layers 32 on the substrate 10 to 10 micrometers or more, as described above, whereby the reliability of the interconnect substrate can be improved.

When the total line width of the catalyst layers 32 is less than 10 micrometers since the desired number of interconnects is small, the interconnect substrate 100 may include dummy interconnects. In this case, it is preferable that the dummy interconnects be disposed on both sides of the interconnect. In other words, it is preferable that the interconnect be disposed between the dummy interconnects. Specifically, when the metal layer 34 formed in the region 40 is an interconnect in FIG. 1, all the metal layers 34 formed in the regions 46 may be dummy interconnects, or the metal layers 34 formed in regions 42 and 44 may be dummy interconnects. When the metal layers 34 formed in the regions 40, 42, and 44 are interconnects, the remaining metal layers 34 may be dummy interconnects. The total line width can be increased by providing the dummy interconnects.

### 1.2. EXPERIMENTAL EXAMPLE 1

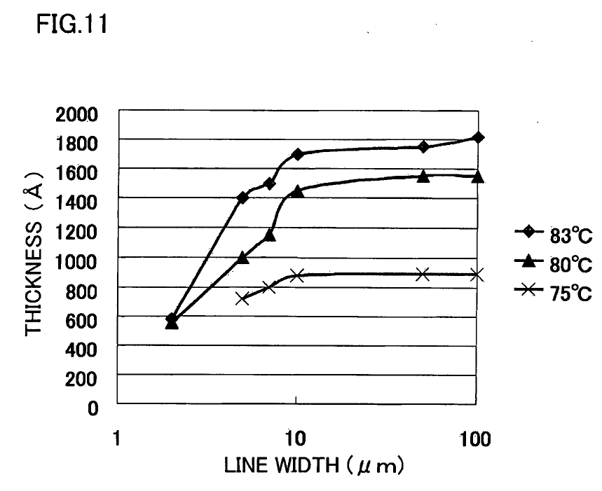

An experiment was conducted in which linear metal layers were formed using the method of manufacturing an interconnect substrate according to the first embodiment, and the thicknesses of the metal layers were measured. FIG. 11 is a graph showing the thickness of the metal layer with respect to the line width of the catalyst layer. A specific metal layer formation method was as follows.

(1) A photoresist film was formed on a glass substrate. The photoresist film was exposed and developed by using a direct writing method in the shape of straight lines with a width of about 1 to 100 micrometers to form a photoresist having linear openings with a width of about 1 to 100 micrometers.

(2) The glass substrate was cut into a 1×1 cm square. The glass substrate was immersed in a cationic surfactant solution (FPD conditioner manufactured by Technic Japan Incorporated). The glass substrate was then immersed in a palladium catalyst solution. The photoresist on the glass substrate was removed using an organic solvent such as acetone. Linear catalyst layers with a width of about 1 to 100 micrometers were thus formed.

(3) The glass substrate on which the catalyst layers were formed was immersed in a nickel electroless plating solution (FPD nickel manufactured by Technic Japan Incorporated) at 83° C., 80° C., or 75° C. for about two minutes to form metal layers.

As shown in FIG. 11, the metal layer was formed to a larger thickness as the line width was increased. When the line width was about 10 micrometers or more, the thickness of the metal layer changed to only a small extent even if the line width was further increased. Therefore, it was confirmed that the thickness of the metal layer changes depending on the line width when the line width is less than about 10 micrometers. According to the experiment, it was found that a metal is deposited to only a small extent when the line width is 2 micrometers or less, thereby making it difficult to form a metal layer.

### 1.3. EXPERIMENTAL EXAMPLE 2

(1) A photoresist film was formed on a glass substrate. The photoresist film was exposed and developed by using a direct writing method in the shape of straight lines with a width of about 0.2 micrometers to form a photoresist having straight lines with a width of about 0.8 micrometers and a plurality of rows of linear openings with a width of about 0.2 micrometers. The total line width was about 16 micrometers.

(2) The glass substrate was cut into a 1×1 cm square. The glass substrate was immersed in a cationic surfactant solution (FPD conditioner manufactured by Technic Japan Incorporated). The glass substrate was then immersed in a palladium catalyst solution. The photoresist on the glass substrate was removed using an organic solvent such as acetone. A stripe-shaped catalyst layer having straight lines with a width of about 0.8 micrometers at intervals of about 0.2 micrometers was thus formed.

(3) The glass substrate on which the catalyst layer was formed was immersed in a nickel electroless plating solution (FPD nickel manufactured by Technic Japan Incorporated) at 80° C. for about two minutes to form metal layers. The thickness of the metal layer was about 150 nm.

According to the method of manufacturing an interconnect substrate according to the first embodiment, since the total line width of the catalyst layers 32 was adjusted to 10 micrometers or more, it was confirmed that the metal layers with a uniform thickness were formed even if the line width was 2 micrometers or less. It was also confirmed that the metal layers with a uniform thickness were formed, even if the line width was 2 micrometers or less, by adjusting the line interval to a value twice or less of the line width.

### 2. Electronic Device

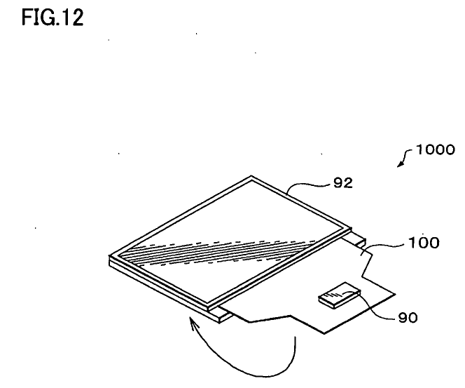

FIG. 12 shows an example of an electronic device to which an interconnect substrate manufactured by using the method of manufacturing an interconnect substrate according to the first embodiment is applied. An electronic device 1000 includes the interconnect substrate 100, an integrated circuit chip 90, and another substrate 92.

The interconnect pattern formed on the interconnect substrate 100 may be used to electrically connect electronic parts. The interconnect substrate 100 is manufactured by the above described manufacturing method. In the example shown in FIG. 12, the integrated circuit chip 90 is electrically connected with the interconnect substrate 100, and one end of the interconnect substrate 100 is electrically connected with the other substrate 92 (e.g. display panel). The electronic device 1000 may be a display device such as a liquid crystal display device, a plasma display device, or an electroluminescent (EL) display device.

### 3. Modification

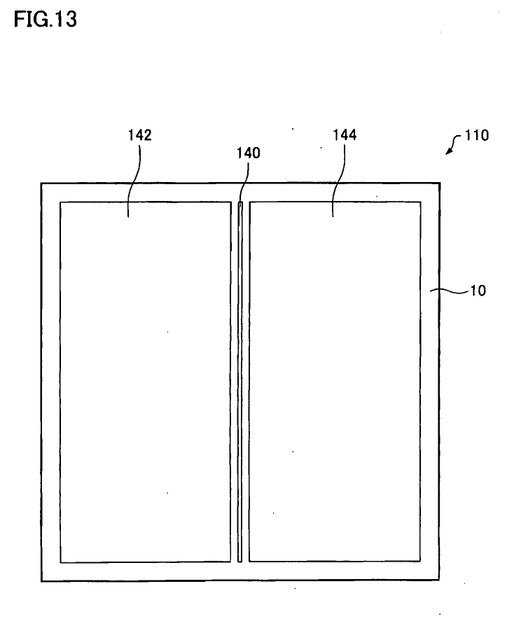

A modification according to the first embodiment is described below. FIG. 13 is a plan diagram showing a method of manufacturing an interconnect substrate according to the modification. FIG. 13 corresponds to FIG. 1. An interconnect substrate 110 according to the modification differs from the interconnect substrate 100 according to the first embodiment as to the planar shape of the catalyst layer and the metal layer formed.

In the interconnect substrate 110, the catalyst layers 32 and the metal layers 34 are formed in regions 140, 142, and 144. The line width of the catalyst layer 32 formed in the region 140 may be 2 micrometers or less. The metal layers 34 formed in the regions 142 and 144 may be dummy interconnects, for example. In this case, the line widths of the metal layers 34 formed in the regions 142 and 144 may not be 2 micrometers or less. The thickness of the metal layer 34 formed in the region 140 can be uniformly increased by disposing the dummy interconnects with a line width of 2 micrometers or more on both sides of the interconnect.

The remaining configuration and the manufacturing method of the interconnect substrate according to the modification are the same as the configuration and the manufacturing method of the interconnect substrate according to the first embodiment. Therefore, further description is omitted.

### 4. Second Embodiment

### 4.1. INTERCONNECT SUBSTRATE

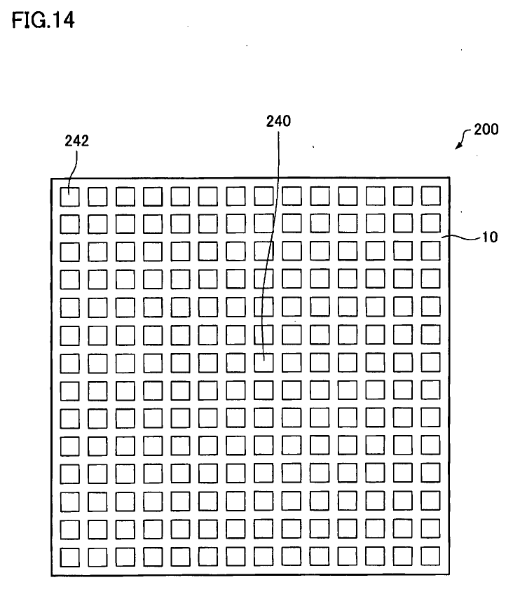

A second embodiment is described below. An interconnect substrate 200 according to the second embodiment differs from the interconnect substrate 100 according to the first embodiment as to the planar shape of the catalyst layer and the metal layer formed. FIG. 14 is a plan diagram showing a method of manufacturing an interconnect substrate according to the second embodiment. FIG. 14 corresponds to FIG. 1.

In the interconnect substrate 200, the catalyst layers 32 and the metal layers 34 are formed in pad-shaped (island-like) regions 240 and 242, as shown in FIG. 14. The regions 240 and 242 may be separated, as shown in FIG. 14. The catalyst layer formed in at least one of the regions 240 and 242 may have a square planar shape with a side length of 2 micrometers or less, and may have an area of 4 square micrometers or less. This region is preferably enclosed by a plurality of catalyst layers, and may be the region 240. The total area of the catalyst layers on the substrate 10 may be 49 square micrometers or more. Therefore, when the catalyst layers formed in the regions 240 and 242 are in the shape of a square with a side length of 0.5 micrometers (i.e. the area of each catalyst layer is 0.25 square micrometers), 196 or more catalyst layers with an area of 0.25 square micrometers are provided on the substrate 10. The interval between the catalyst layers may be twice or less of the side length of the square, for example.

When the total area of the catalyst layers 32 is less than 49 square micrometers since the desired number of pads is small, the interconnect substrate 200 may include dummy interconnects. In this case, it is preferable that the dummy interconnects be disposed around the interconnect. In other words, it is preferable that the interconnect be enclosed by the dummy interconnects. Specifically, when all of the square regions on the substrate 10 other than the region 240 are the regions 242 in FIG. 14, the metal layers 34 formed in all of the regions 242 may be dummy interconnects, or the metal layers 34 formed in arbitrary regions 242 may be dummy interconnects. The total area of the catalyst layers can be increased by providing the dummy interconnects.

The remaining configuration and the manufacturing method of the interconnect substrate according to the second embodiment are the same as the configuration and the manufacturing method of the interconnect substrate according to the first embodiment. Therefore, further description is omitted.

### 4.2. EXPERIMENTAL EXAMPLE 3

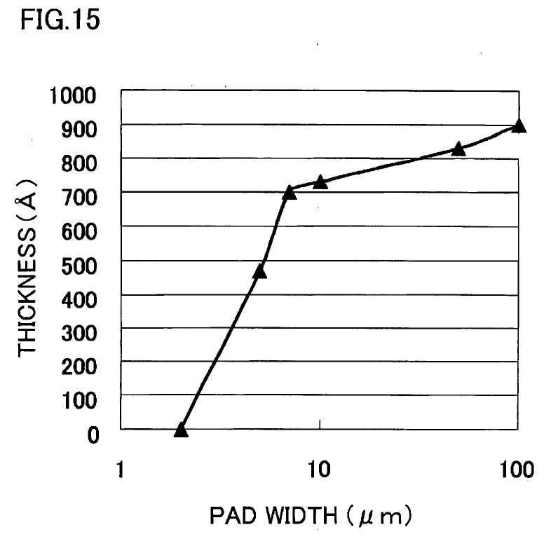

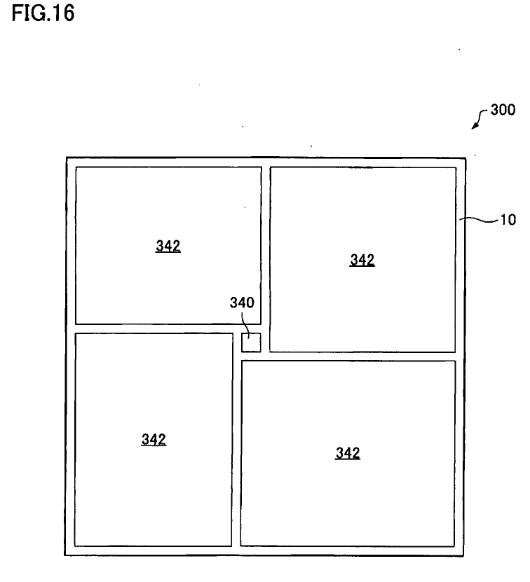

An experiment was conducted in which pad-shaped metal layers were formed using the method of manufacturing an interconnect substrate according to the second embodiment, and the thicknesses of the metal layers were measured. FIG. 15 is a graph showing the thickness of the metal layer with respect to the pad width (one side of square) of the catalyst layer. A specific metal layer formation method was as follows.

(1) A photoresist film was formed on a glass substrate. The photoresist film was exposed and developed using a direct writing method in the shape of pads with a width of about 1 to 100 micrometers to form a photoresist having pad-shaped openings with a width of about 1 to 100 micrometers.

(2) The glass substrate was cut into a 1×1 cm square. The glass substrate was immersed in a cationic surfactant solution (FPD conditioner manufactured by Technic Japan Incorporated). The glass substrate was then immersed in a palladium catalyst solution. The photoresist on the glass substrate was removed using an organic solvent such as acetone. Pad-shaped catalyst layers with a width of about 1 to 100 micrometers were thus formed.

(3) The glass substrate on which the catalyst layers were formed was immersed in a nickel electroless plating solution (FPD nickel manufactured by Technic Japan Incorporated) at 80° C. for about two minutes to form metal layers.

As shown FIG. 15, the metal layer was formed to a larger thickness as the pad width was increased. When the pad width was less than about 7 micrometers (i.e. pad area was less than 49 square micrometers), the thickness of the metal layer was increased to a large extent as the pad width was increased. On the other hand, when the pad width was about 7 micrometers or more (i.e. pad area was 49 square micrometers or more), the thickness of the metal layer changed to only a small extent even if the pad area was increased. When the pad width was 2 micrometers or less (i.e. pad area was 4 square micrometers or less), it was found that it is difficult to form a metal layer since a metal is not deposited.

### 4.3. EXPERIMENTAL EXAMPLE 4

(1) A photoresist film was formed on a glass substrate. The photoresist film was exposed and developed using a direct drawing method to form a photoresist having pad-shaped openings with a width of about 500 nm. The total pad width was about 7 micrometers.

(2) The glass substrate was cut into a 1×1 cm square. The glass substrate was immersed in a cationic surfactant solution (FPD conditioner manufactured by Technic Japan Incorporated). The glass substrate was then immersed in a palladium catalyst solution. The photoresist on the glass substrate was removed using an organic solvent such as acetone. Catalyst layers were thus formed in the pad-shaped regions with a width of about 500 nm, as shown in FIG. 14. The pad interval was about 500 nm.

(3) The glass substrate on which the catalyst layers were formed was immersed in a nickel electroless plating solution (FPD nickel manufactured by Technic Japan Incorporated) at 80° C. for about two minutes to form metal layers. The thickness of the metal layer was about 150 nm.

According to the method of manufacturing an interconnect substrate according to the second embodiment, since the total pad area of the catalyst layers 32 was adjusted to 49 square micrometers or more, it was confirmed that the metal layers with a uniform thickness were formed even if the pad area was 4 square micrometers or less.

### 4.4. MODIFICATION

A modification according to the second embodiment is described below. FIG. 16 is a plan diagram showing a method of manufacturing an interconnect substrate according to the modification. FIG. 16 corresponds to FIG. 1. An interconnect substrate 300 according to the modification differs from the interconnect substrate 200 according to the second embodiment as to the planar shape of the catalyst layer and the metal layer formed.

In the interconnect substrate 300, the catalyst layers 32 and the metal layers 34 are formed in regions 340 and 342. The pad width of the catalyst layer 32 in the region 340 may be 2 micrometers or less. The metal layers 34 formed in the regions 342 may be dummy interconnects, for example. In this case, the pad widths of the metal layers 34 formed in the regions 342 may not be 2 micrometers or less. The thickness of the metal layer 34 formed in the region 340 can be uniformly increased by disposing the dummy interconnects with a pad width of 2 micrometers or more on both sides of the interconnect.

The remaining configuration and the manufacturing method of the interconnect substrate according to the modification are the same as the configuration and the manufacturing method of the interconnect substrate according to the second embodiment. Therefore, further description is omitted.

The invention is not limited to the above-described embodiments. Various modifications and variations may be made. In the above-described embodiments, the resist layer is provided in advance on the substrate in the region other than the desired pattern region, the surfactant layer and the catalyst layer are formed on the entire surface, and the catalyst layer is formed in a specific region by removing the resist layer. Note that the catalyst layer may be formed without using the resist layer. Specifically, the surfactant layer is formed on the entire surface of the substrate, and the surfactant layer is partially optically decomposed to allow the surfactant layer to remain only in the desired pattern region. This allows the catalyst layer to be formed only in the desired pattern region. The surfactant layer may be optically decomposed using vacuum ultraviolet (VUV) radiation. An interatomic bond (e.g. C—C, C═C, C—H, C—F, C—Cl, C—O, C—N, C═O, O═O, O—H, H—F, H—Cl, and N—H) can be cut by setting the wavelength of light at 170 to 260 nm, for example. It becomes unnecessary to provide a yellow room or the like by using the above wavelength band, whereby a series of steps according to this embodiment may be performed under white light, for example.

The invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of the invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A method of manufacturing an interconnect substrate having a linear interconnect by electroless plating without using a plating resist, the method comprising:
(a) forming a plurality of rows of linear catalyst layers on a substrate; and
(b) depositing a metal on the linear catalyst layers by electroless plating to form a plurality of rows of linear metal layers,
at least one of the rows of linear catalyst layers having a line width of 2 micrometers or less, and a total line width of the linear catalyst layers on the substrate being 10 micrometers or more.

2. The method of manufacturing an interconnect substrate as defined in claim 1,
wherein the total line width of the linear catalyst layers on the substrate is 20 micrometers or more.

3. The method of manufacturing an interconnect substrate as defined in claim 1,
wherein the rows of metal layers include interconnects and dummy interconnects.

4. The method of manufacturing an interconnect substrate as defined in claim 3,
wherein the dummy interconnects are formed on both sides of the interconnect.

5. The method of manufacturing an interconnect substrate as defined in claim 1, further comprising:
forming a resist layer on the substrate in a region other than a region of a desired interconnect pattern before the step (a); and
forming a surfactant layer on the substrate before the step (a),
wherein the step (a) includes:
forming a linear catalyst layer on the surfactant layer; and
removing the resist layer to remove part of the surfactant layer and the catalyst layer in the region other than the region of the desired interconnect pattern.

6. The method of manufacturing an interconnect substrate as defined in claim 1,
wherein, in the step (b), nickel is deposited on the linear catalyst layers by immersing the substrate in an electroless plating solution including nickel.

7. A method of manufacturing an interconnect substrate by electroless plating without using a plating resist, the method comprising:
(a) forming catalyst layers in a plurality of regions on a substrate; and
(b) depositing a metal on the catalyst layers by electroless plating to form metal layers in the regions,
part of the catalyst layers formed in at least one of the regions having an area of 4 square micrometers or less, and a total area of the catalyst layers being 49 square micrometers or more.

8. The method of manufacturing an interconnect substrate as defined in claim 7,
wherein another catalyst layer for forming a dummy interconnect is formed around the part of the catalyst layers formed in the one region.

9. The method of manufacturing an interconnect substrate as defined in claim 7, further comprising:
forming a resist layer on the substrate in a region other than a region of a desired interconnect pattern before the step (a); and
forming a surfactant layer on the substrate before the step (a),
wherein the step (a) includes:
forming a catalyst layer on the surfactant layer; and
removing the resist layer to remove part of the surfactant layer and the catalyst layer in the region other than the region of the desired interconnect pattern.

10. The method of manufacturing an interconnect substrate as defined in claim 7,
wherein, in the step (b), nickel is deposited on the catalyst layers by immersing the substrate in an electroless plating solution including nickel.
